(19) United States
(12) Patent Application Publication
(10) Pub. No.: US 2024/0241234 A1
(43) Pub. Date: Jul. 18, 2024

(54) SYNCHRONIZATION METHOD AND DEVICE FOR ROTATING LIDAR AND CAMERA USING MULTIPLE SIGNALS

(71) Applicant: MOBILTECH, Seoul (KR)

(72) Inventor: Jae Seung KIM, Seoul (KR)

(21) Appl. No.: 18/339,292

(22) Filed: Jun. 22, 2023

(30) Foreign Application Priority Data
Jan. 12, 2023 (KR) 10-2023-0004677

(51) Int. Cl. G01S 7/497; G01S 7/481; G01S 7/4861; G01S 17/86

(52) U.S. Cl. CPC G01S 7/497; G01S 7/4817; G01S 7/4861; G01S 17/86

(57) ABSTRACT

A synchronization device according to an embodiment may include a Light Detection and Ranging (LiDAR), a plurality of cameras, and a synchronization control unit, and a method of synchronizing a rotating LiDAR and a camera according to an embodiment may include the steps of: outputting a sample according to a predetermined output period while rotating, by the LiDAR; acquiring the output sample, and deriving a trigger timing, which is an expected time for the LiDAR to rotate from a current position to a trigger target on the basis of the sample, by the synchronization control unit; transmitting a first trigger signal to the first camera and the second camera after a time of the trigger timing elapses, by the synchronization control unit; and additionally transmitting a second trigger signal only to the second camera after transmitting the first trigger signal, by the synchronization control unit.

### BACKGROUND OF THE INVENTION

### Field of the Invention

The present invention relates to a method of synchronizing a rotating LiDAR and a camera using multiple signals and a device therefor, and more specifically, to a method of synchronizing output data of a plurality of cameras using multiple signals and a rotating LiDAR, and a device therefor.

### Background of the Related Art

Various types of visual sensors such as LiDAR (Light Detection and Ranging) and cameras are widely used in autonomous vehicle systems to recognize and determine surrounding environments in real time, and the autonomous vehicle system operates basically assuming time synchronization between these various visual sensors. In general, visual sensor synchronization between several types of cameras can be accomplished relatively easily when a device that quickly provides time information, such as a Global Positioning System (GPS), is used. However, it is difficult to secure precise synchronization between a rotating LiDAR, which acquires surrounding distance information while rotating based only on the time information provided from an external device, and a camera that acquires visual information in a specific range at once.

Currently, all LiDARs except LiDARs of a solid-state type are rotating LiDARs. As described above, the method of synchronizing an existing rotating LiDAR and a camera stores time information when the camera photographs using time information of an external device and time information of 3D data obtained while the LiDAR rotates, and matches and uses most similar time values among the stored time information. Although the synchronized data may be sufficient for general purposes, it is not suitable for be used in an algorithm used in an autonomous vehicle system or the like that requires sophisticated matching between a LiDAR and a camera. To solve this problem, the Karlsruhe Institute of Technology in Germany has solved the time synchronization problem by installing a hardware switch on a rotating LiDAR to physically provide a synchronization signal to the camera. However, this method has a durability problem due to the physical switch.

Unsophisticated time synchronization between a rotating LiDAR and a camera generates a fundamental error in data matching, and this may act critically in operating visual sensors of autonomous vehicle systems that should guarantee stable results in a wide variety of outdoor environments.

In the case of using a plurality of cameras, each camera has a different sampling rate, so that synchronization is accomplished on the basis of a camera having the lowest sampling rate. This may waste performance of a camera having a relatively high sampling rate. Demands for a method capable of fully utilizing performance of a camera while synchronizing a LiDAR and the camera are increasing.

(Patent Document 1) Korean Patent Registration No. 10-1899549

### SUMMARY OF THE INVENTION

Therefore, the present invention has been made in view of the above problems, and it is an object of the present invention to provide a method and device for synchronizing a rotating

LiDAR and a camera using multiple signals.

The technical problems of the present invention are not limited to the technical problems mentioned above, and unmentioned other technical problems will be clearly understood by those skilled in the art from the following description.

To accomplish the above object, according to one aspect of the present invention, there is provided a device for synchronizing a LiDAR and a camera including the LiDAR, a synchronization device, and one or more cameras.

To accomplish the above object, according to one aspect of the present invention, there is provided a method of synchronizing a LiDAR and a camera, and the method comprises the steps of: outputting a sample according to a predetermined output period while rotating, by the LiDAR; acquiring the output sample, and deriving a trigger timing, which is an expected time for the LiDAR to rotate from a current position to a trigger target on the basis of the sample, by the synchronization control unit; transmitting a first trigger signal to the first camera and the second camera after a time of the trigger timing elapses, by the synchronization control unit; and additionally transmitting a second trigger signal only to the second camera after transmitting the first trigger signal, by the synchronization control unit, wherein the first camera and the second camera share the same angle of view, the sample includes a rotation angle indicating a current position of the LiDAR, the trigger target indicates a virtual direction in which centers of angles of view of the first camera, the second camera, and the LiDAR are in line with each other, and the rotation angle indicates an angle at which the LiDAR rotates with respect to the trigger target.

According to the present invention as described above, as the rotational angular velocity of a rotating LiDAR is measured in real time, there is an effect of predicting a moment when the LiDAR is in line with the photographing direction of the camera.

In addition, according to the present invention as described above, as a trigger signal is transmitted to the camera at the moment when the LiDAR is in line with the photographing direction of the camera, there is an effect of matching sensing data of the LiDAR and image data of the camera.

In addition, there is an effect of maximally utilizing performance of a camera having a high operating signal while synchronizing with a LiDAR using cameras having different operating signals.

### BRIEF DESCRIPTION OF THE DRAWINGS

FIG. 1 is a perspective view showing a device for synchronizing a LiDAR and a camera according to an embodiment of the present invention.

FIG. 2 is a block diagram showing the configuration of a device for synchronizing a LiDAR and a camera according to an embodiment of the present invention.

FIG. 3 is a block diagram showing the configuration of a synchronization control unit according to an embodiment of the present invention.

FIG. 4 is a signal graph showing a trigger signal according to an embodiment of the present invention.

FIG. 5 is a flowchart illustrating a method of synchronizing a LiDAR and a camera according to an embodiment of the present invention.

### DETAILED DESCRIPTION OF THE PREFERRED EMBODIMENT

Hereinafter, preferred embodiments of the present invention will be described in detail with reference to the accompanying drawings. Advantages and features of the present invention and methods for achieving them will become clear with reference to the embodiments described below in detail in conjunction with the accompanying drawings. However, the present invention is not limited to the embodiments disclosed below and may be implemented in various different forms, and these embodiments are provided only to make the disclosure of the present invention complete and to fully inform those skilled in the art of the scope of the present invention, and the present invention is only defined by the scope of the claims. Like reference numbers refer to like elements throughout the specification.

Unless otherwise defined, all terms (including technical and scientific terms) used in this specification can be used as a meaning that can be commonly understood by those skilled in the art. In addition, terms defined in commonly used dictionaries are not interpreted ideally or excessively unless explicitly and specifically defined.

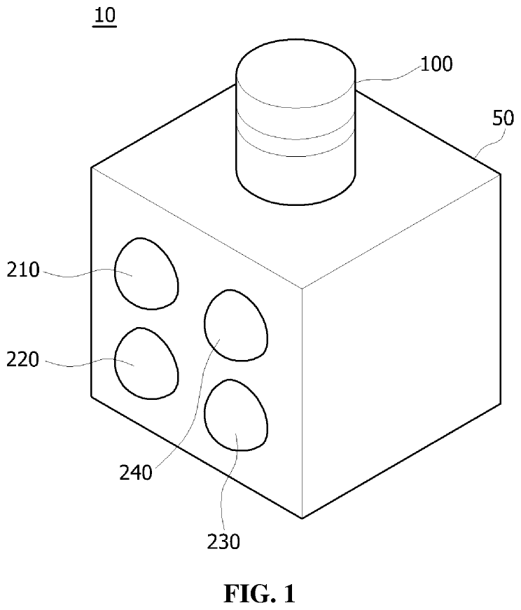

FIG. 1 is a perspective view showing a device for synchronizing a LiDAR and a camera according to an embodiment of the present invention. The device for synchronizing a LiDAR and a camera will be described with reference to FIG. 1.

The device for synchronizing a LiDAR and a camera shown in FIG. 1 is only an example according to an embodiment of the present invention, and it is not limited thereto.

Referring to FIG. 1, a device 10 for synchronizing a LiDAR and a camera according to an embodiment of the present invention may include a LiDAR 100, a plurality of cameras 210, 220, 230, and 240, and a main body 50.

The LiDAR 100 may include a transmitter and a receiver. The transmitter emits light pulses towards the surrounding environments of the LiDAR. The receiver detects reflections of the emitted light pulses. The LiDAR 100 may output point cloud data obtained by measuring distance to objects located in the surrounding environments by emitting and receiving light pulses to and from the surrounding environments while rotating.

The LiDAR 100 and the cameras 210, 220, 230, and 240 may be mounted on the main body 50. A synchronization control unit for controlling the LiDAR 100 and the cameras 210, 220, 230, and 240 may be additionally mounted inside the main body 50.

The cameras 210, 220, 230, and 240 may include one or more cameras. The cameras 210, 220, 230, and 240 may include a first camera 210, a second camera 220, a third camera 230, and a fourth camera 240. Although four cameras are shown in the present invention for convenience of explanation, the number of cameras is not limited thereto.

Each camera included in the cameras 210, 220, 230, and 240 may be disposed on the main body 50 to share an angle of view in the same direction. As shown in FIG. 1, as the cameras are disposed adjacent to each other, the same angle of view can be shared. Accordingly, the cameras 210, 220, 230, and 240 may share the same trigger target with respect to the LiDAR 100. Those shown in FIG. 1 are only an example and not limited thereto.

The cameras 210, 220, 230, and 240 may include any one among a color camera, a near infrared (NIR) camera, a short wavelength infrared (SWIR) camera, and a long wavelength infrared (LWIR) camera.

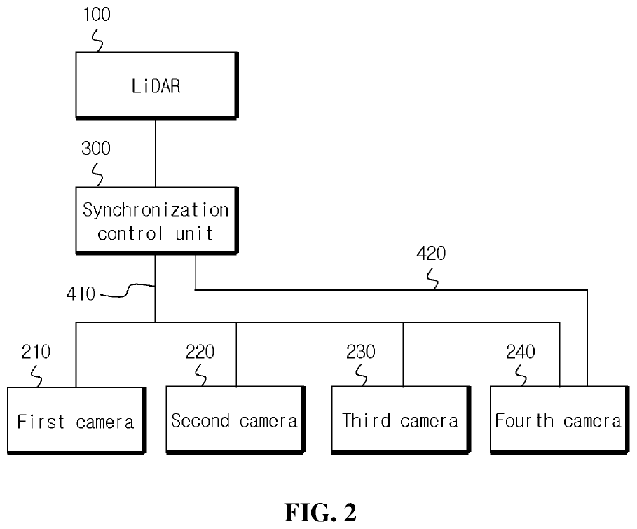

FIG. 2 is a block diagram showing the configuration of a device for synchronizing a LiDAR and a camera according to an embodiment of the present invention.

Referring to FIG. 2, the device 10 for synchronizing a LiDAR and a camera according to an embodiment of the present invention may include a LiDAR 100, a synchronization control unit 300, and one or more cameras 210, 220, 230, and 240.

Hereinafter, the first camera 210 and the second camera 220 will be described as an example for convenience of explanation. The third camera 230 and the fourth camera 240 operate in the same way since they are connected to a first signal line 410 the same as that of the first camera 210, and only the second camera 220 is connected to a second signal line 420 different from the first signal line 410. The first camera 210 to the fourth camera 240 are arbitrarily classified according to the connected signal lines, and it is not limited thereto.

The LiDAR 100 may output a sample including a rotation angle indicating the current position at every predetermined output period T_{reload}.

The synchronization control unit 300 may acquire the output sample, derive trigger timing, which is a time expected for the LiDAR to rotate from the current position to the trigger target, on the basis of the sample, transmit a first trigger signal to the first camera 210 and the second camera 220 after the time of the trigger timing elapses, and additionally transmit a second trigger signal only to the second camera 220 after transmitting the first trigger signal.

The synchronization control unit 300 may acquire a minimum operation period on the basis of the operating frequency of the second camera 220. The synchronization control unit 300 may transmit the second trigger signal only to the second camera 220 when the minimum operation period elapses after transmitting the first trigger signal.

The synchronization control unit 300 may additionally transmit the second trigger signal only to the second camera 220 when the minimum operation period elapses after transmitting the second trigger signal.

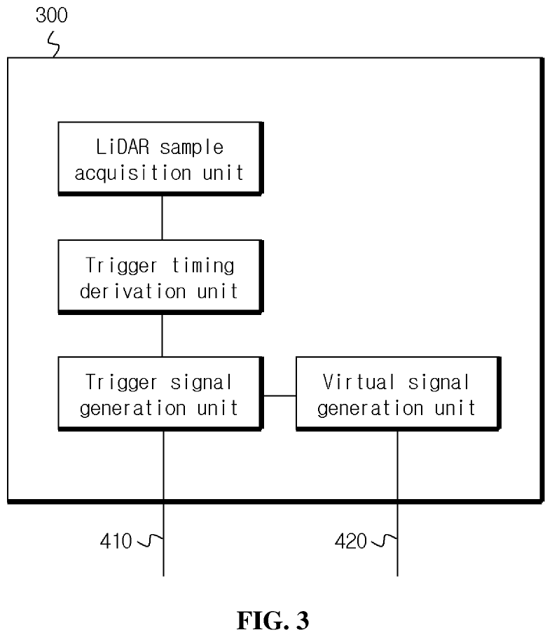

FIG. 3 is a block diagram showing the configuration of a synchronization control unit according to an embodiment of the present invention. The configuration of the synchronization control unit 300 will be described with reference to FIG. 3.

The synchronization control unit 300 may include a LiDAR sample acquisition unit 310, a trigger timing derivation unit 320, a trigger signal generation unit 330, a virtual signal generation unit 340, a first signal line 410, and a second signal line 420.

The LiDAR sample acquisition unit 310 may acquire a sample output from the LiDAR 100, store the rotation angle included in the acquired sample in an internal storage, and update an acquired sample count indicating the number of acquired samples.

The LiDAR sample acquisition unit 310 may increase the value of the acquired sample count by 1 whenever a new sample is acquired.

The LiDAR sample acquisition unit 310 may derive an average value by dividing the total sum of a value of difference between the rotation angle included in the acquired sample and the rotation angle included in the previously acquired sample by the acquired sample count.

The LiDAR sample acquisition unit 310 may continue acquiring samples when the acquired sample count is smaller than a predetermined target sample count N.

The target sample count N may be determined according to specifications of the LiDAR 100. It may be determined by the number of revolutions per second and the output period T_{reload} of the LiDAR 100. The integer part of a value obtained by dividing the angle difference with the trigger target by a product of the angular velocity and the output period T_{reload} may be the target sample count N.

For example, when the number of revolutions per second is 10, the LiDAR rotates 3600 degrees per second, and the angular velocity is 3600/s. When the output period T_{reload} is 0.01 second, the LiDAR may rotationally move 36 degrees that is calculated by multiplying 3600 degrees by 0.01 seconds in one output period T_{reload}, and when there is only one trigger target, the angle difference with the trigger target is 360 degrees, and 10, which is a value obtained by dividing 360 degrees by 36 degrees, may be the target sample count N.

When the acquired sample count is equal to the target sample count N, the trigger timing derivation unit 320 may derive a value obtained by dividing the average value by the output period T_{reload} as the average angular velocity.

The trigger timing deriving unit 320 may acquire a gap angle, which is an angle difference between a point where the LiDAR 100 most recently outputs a sample and the trigger target.

The trigger timing derivation unit 320 may derive a value obtained by dividing the gap angle by the average angular velocity as the trigger timing.

The trigger signal generating unit 330 may transmit a first trigger signal to the plurality of cameras 210, 220, 230, and 240 through the first signal line 410 when the time of the trigger timing time elapses.

The virtual signal generation unit 340 may transmit the second trigger signal only to the second camera 220 through the second signal line 420. The virtual signal generation unit 340 may acquire a minimum operation period on the basis of the operating frequency of the second camera 220. The virtual signal generation unit 340 may transmit the second trigger signal only to the second camera 220 through the second signal line 420 when the minimum operation period elapses after the first trigger signal is transmitted.

According to another embodiment of the present invention, the trigger timing derivation unit 320 may adjust the trigger timing in consideration of the response time of the cameras 210, 220, 230, and 240. The response time means a time required for the camera to actually start photographing after receiving a trigger signal. Each camera may have a different response time according to the type.

For example, compared to a general color camera, an infrared camera may have a longer response time as the sensor needs time to respond to heat.

The trigger timing derivation unit 320 according to another embodiment of the present invention may acquire a first response time of the first camera 210 and derive a first timing by subtracting the first response time from the trigger timing.

The trigger timing derivation unit 320 according to another embodiment of the present invention may acquire a second response time of the second camera 220 and derive a second timing by subtracting the second response time from the trigger timing.

The trigger timing derivation unit 320 according to another embodiment of the present invention may acquire a third response time of the third camera 230 and derive a third timing by subtracting the third response time from the trigger timing.

The trigger timing derivation unit 320 according to another embodiment of the present invention may acquire a fourth response time of the fourth camera 240 and derive a fourth timing by subtracting the fourth response time from the trigger timing.

The trigger signal generation unit 330 according to another embodiment of the present invention may transmit the first trigger signal to the cameras 210, 220, 230, and 240 when the time of the adjusted trigger timing elapses.

The trigger signal generation unit 330 according to another embodiment of the present invention may transmit the first trigger signal to the first camera 210 when the time of the first timing elapses.

The trigger signal generation unit 330 according to another embodiment of the present invention may transmit the first trigger signal to the second camera 220 when the time of the second timing elapses.

The trigger signal generation unit 330 according to another embodiment of the present invention may transmit a third trigger signal to the third camera 230 when the time of the third timing elapses.

The trigger signal generation unit 330 according to another embodiment of the present invention may transmit the first trigger signal to the fourth camera 240 when the time of the fourth timing elapses.

The trigger signal generation unit 330 according to another embodiment of the present invention may also perform an operation of transmitting a trigger signal to each camera in parallel. A separate process or thread may be used. Parallel processing may be performed by executing separate processes that checks the time of the first to fourth timings.

When the cameras 210, 220, 230, and 240 according to another embodiment of the present invention receive the first trigger signal, respectively, they may prepare for photographing. The cameras 210, 220, 230, and 240 may respectively start photographing after the first to fourth response times elapse.

The virtual signal generation unit 340 according to another embodiment of the present invention may transmit the second trigger signal through the second signal line 420 when the time of the minimum operation period of the second camera 220 elapses after the first trigger signal is transmitted.

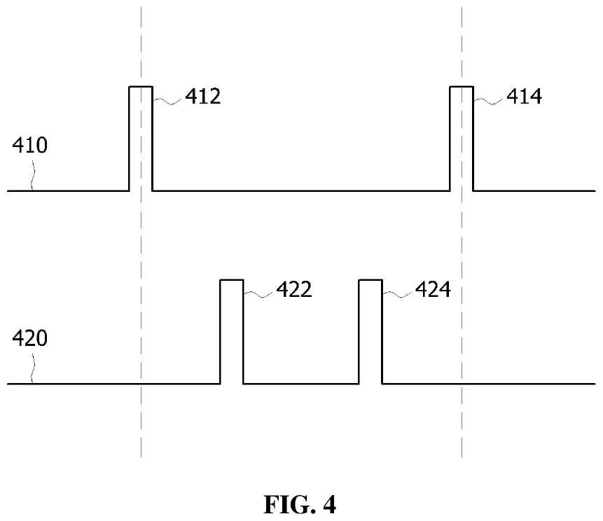

FIG. 4 is a signal graph showing a trigger signal according to an embodiment of the present invention.

Referring to FIG. 4, the first trigger signals 412 and 414 may be transmitted through the first signal line 410, and the second trigger signals 422 and 424 may be transmitted through the second signal line 420.

A plurality of second trigger signals 422 and 424 may be transmitted at regular intervals while the first trigger signals 412 and 414 are transmitted.

For example, the first camera 210 may operate at 10 Hz, and the second camera 220 may be a camera capable of operating at 30 Hz. In this case, the first trigger signals 412 and 414 may be transmitted at time intervals corresponding to 10 Hz. The second trigger signals 422 and 424 may be transmitted at time intervals of 20 Hz between the first trigger signals 412 and 414. Accordingly, the first camera 210 that receives only the trigger signal of the first signal line 410 may operate at 10 Hz, and the second camera 220 that receives the trigger signal from both the first signal line 410 and the second signal line 420 may operate at 30 Hz.

For example, a color camera, a NIR camera, and a SWIR camera may operate at 10 Hz, and an LWIR camera may operate at 30 Hz.

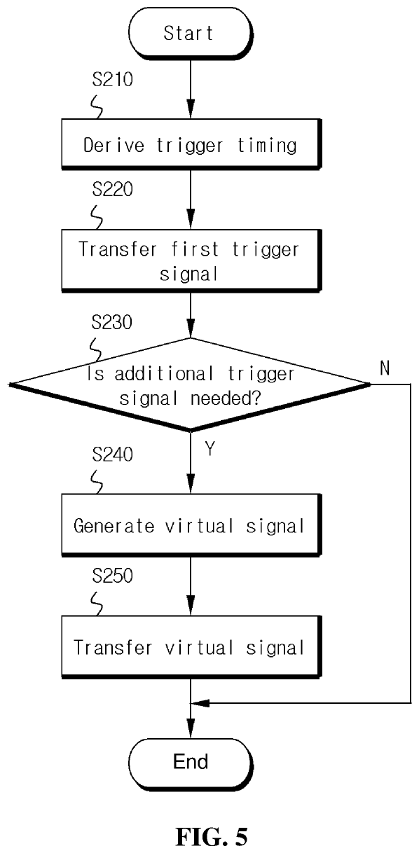

FIG. 5 is a flowchart illustrating a method of synchronizing a LiDAR and a camera according to an embodiment of the present invention. The method of synchronizing a LiDAR and a camera will be described with reference to FIG. 5.

The synchronization control unit 300 derives trigger timing (S210).

The synchronization control unit 300 acquires samples output from the LiDAR 100 and increases the value of an acquired sample count indicating the number of previously acquired samples by 1. The synchronization control unit 300 derives an average value by dividing the total sum of a value of difference between the rotation angle included in the acquired sample and the rotation angle included in the previously acquired sample by the acquired sample count. The synchronization control unit 300 continues acquiring samples when the acquired sample count is smaller than a predetermined target sample count. When the acquired sample count is equal to the target sample count, the synchronization control unit 300 derives a value obtained by dividing the average value by the output period as an average angular velocity, acquires a gap angle, which is an angle difference between a rotation angle included in a most recently acquired sample and the trigger target, and derives a value obtained by dividing the gap angle by the average angular velocity as the trigger timing.

The synchronization control unit 300 transmits the first trigger signal to the first camera 210 and the second camera 220 (S220).

When the operating frequency of the second camera 220 is higher than that of the first camera 210, the synchronization control unit 300 determines that an additional trigger signal is required (S230).

The synchronization control unit 300 acquires a minimum operation period of the second camera 220, generates a second trigger signal, and waits until the minimum operation period elapses (S240).

The synchronization control unit 300 transmits the second trigger signal only to the second camera 220 (S250).

Although the embodiments of the present invention have been described with reference to the accompanying drawings, those skilled in the art will understand that the present invention can be embodied in other specific forms without changing its technical spirit or essential features. Therefore, the embodiments described above should be understood as illustrative in all respects and not limiting.

### DESCRIPTION OF SYMBOLS

10: Device for synchronizing LiDAR and camera
100: LiDAR
210, 220, 230, 240: Camera
300: Synchronization control unit

What is claimed is:

1. A method of synchronizing a Light Detection and Ranging (LiDAR) and a camera in a device including the LiDAR, a first camera, a second camera, and a synchronization control unit, the method comprising the steps of:
outputting a sample according to a predetermined output period while rotating, by the LiDAR;
acquiring the output sample, and deriving a trigger timing, which is an expected time for the LiDAR to rotate from a current position to a trigger target on the basis of the sample, by the synchronization control unit;
transmitting a first trigger signal to the first camera and the second camera after a time of the trigger timing elapses, by the synchronization control unit; and
additionally transmitting a second trigger signal only to the second camera after transmitting the first trigger signal, by the synchronization control unit, wherein
the first camera and the second camera share the same angle of view,
the sample includes a rotation angle indicating a current position of the LiDAR,
the trigger target indicates a virtual direction in which centers of angles of view of the first camera, the second camera, and the LiDAR are in line with each other, and
the rotation angle indicates an angle at which the LiDAR rotates with respect to the trigger target.

2. The method according to claim 1, wherein the step of deriving a trigger timing includes the steps of:
acquiring the output sample, by the synchronization control unit;
increasing a value of an acquired sample count indicating the number of previously acquired samples by 1, by the synchronization control unit;
acquiring a value obtained by dividing a total sum of rotation angles included in the acquired sample and previously acquired samples by the acquired sample count as an average value, by the synchronization control unit;
repeating the step of acquiring the sample when the acquired sample count is smaller than a predetermined target sample count;
deriving a value obtained by dividing the average value by the output period as an average angular velocity when the acquired sample count is equal to the target sample count, by the synchronization control unit;
acquiring a gap angle, which is an angle difference between a rotation angle included in a sample most recently output by the LiDAR and the trigger target, by the synchronization control unit; and
deriving a value obtained by dividing the gap angle by the average angular velocity as the trigger timing, by the synchronization control unit.

3. The method according to claim 1, wherein the step of additionally transmitting a second trigger signal includes the steps of:
acquiring a minimum operation period of the second camera, by the synchronization control unit; and
transmitting the second trigger signal to the second camera when a time of the minimum operation period elapses after transmitting the first trigger signal, by the synchronization control unit.

4. A device for synchronizing a LiDAR and a camera, the device comprising:
a first camera;
a second camera;
a LiDAR for outputting a sample while rotating according to a predetermined output period; and
a synchronization control unit for acquiring the output sample, deriving trigger timing, which is a time expected for the LiDAR to rotate from a current position to a trigger target, on the basis of the sample, transmitting a first trigger signal to the first camera and the second camera after a time of the trigger timing elapses, and additionally transmitting a second trigger signal only to the second camera after transmitting the first trigger signal, wherein
the sample includes a rotation angle indicating the current position of the LiDAR, the trigger target indicates a virtual direction in which centers of angles of view of the first camera, the second camera, and the LiDAR are in line with each other, and the rotation angle indicates an angle at which the LiDAR rotates with respect to the trigger target.

5. The device according to claim 4, wherein the second camera is a camera capable of operating at an operating frequency different from that of the first camera.

6. The device according to claim 4, wherein the synchronization control unit acquires the output sample, by the synchronization control unit, increases a value of an acquired sample count indicating the number of previously acquired samples by 1, acquires a value obtained by dividing a total sum of rotation angles included in the acquired sample and previously acquired samples by the acquired sample count as an average value, repeats the step of acquiring the sample when the acquired sample count is smaller than a predetermined target sample count, derives a value obtained by dividing the average value by the output period as an average angular velocity when the acquired sample count is equal to the target sample count, acquires a gap angle, which is an angle difference between a rotation angle included in a sample most recently output by the LiDAR and the trigger target, and derives a value obtained by dividing the gap angle by the average angular velocity as the trigger timing.

7. The device according to claim 4, wherein the synchronization control unit acquires a minimum operation period of the second camera, and transmits the second trigger signal to the second camera when a time of the minimum operation period elapses after transmitting the first trigger signal.

8. The device according to claim 4, wherein the synchronization control unit includes a first signal line and a second signal line, wherein the first signal line is connected to the first camera and the second camera, and the second signal line is connected only to the second camera.

9. The device according to claim 8, wherein the synchronization control unit transmits the first trigger signal to the first camera and the second camera through the first signal line after the trigger timing elapses, and transmits the second trigger signal only to the second camera using the second signal line when a minimum operation period of the second camera elapses after transmitting the first trigger signal.

10. The device according to claim 4, wherein the first camera and the second camera include any one among a color camera, a near infrared (NIR) camera, a short wavelength infrared (SWIR) camera, and a long wavelength infrared (LWIR) camera.
